(19) United States
(12) Patent Application Publication
(10) Pub. No.: US 2018/0192064 A1
(43) Pub. Date: Jul. 5, 2018

(54) TRANSCODER FOR REAL-TIME COMPOSITING

(71) Applicant: NAVER Corporation, Seongnam-si (KR)

(72) Inventors: Jong Ju Kim, Seongnam-si (KR); Young Dong Jung, Seongnam-si (KR); Sung Jun Choi, Seongnam-si (KR); Jaewon Oh, Seongnam-si (KR)

(21) Appl. No.: 15/863,460

(22) Filed: Jan. 5, 2018

(30) Foreign Application Priority Data
Jan. 5, 2017 (KR) 10-2017-0002047

(51) Int. Cl. H04N 19/40; H04N 19/44; H04N 19/172

(52) U.S. Cl. CPC H04N 19/40; H04N 19/172; H04N 19/44

(57) ABSTRACT

A real-time transcoding method is performed by a server configured as a computer. The server includes a transcoder having a decoder, a mixer, and an encoder, and the method includes performing real-time transcoding of a main image using the transcoder; adding a sub image at a front end of the mixer of the transcoder or removing the added sub image; and mixing or replacing the sub image using the mixer of the transcoder during real-time transcoding of the main image.

### CROSS-REFERENCE TO RELATED APPLICATION(S)

This application claims priority under 35 U.S.C. § 119 to Korean Patent Application No. 10-2017-0002047 filed on Jan. 5, 2017, in the Korean Intellectual Property Office (KIPO), the entire contents of which are incorporated herein by reference.

### BACKGROUND

### Field of the Invention

One or more example embodiments relate to a real-time transcoding technique.

### Description of Related Art

A multimedia streaming service refers to a service for transmitting a moving image file stored in a storage server to a plurality of user terminals corresponding to clients, and allowing data reception and play to be simultaneously performed at each user terminal. The importance of this type of service is widely recognized with the current spread of mobile and cloud environments.

Transcoding refers to converting a format, for example, a file format, or a resolution and an image quality of multimedia content. In a streaming service, many multimedia files stored in the storage server have high quality and large capacity in many cases, which may not be suitable for transmission to and play at a mobile terminal. Also, if a format of source content stored in a server is not supported by a client, there is a need to convert the format of source content.

Since transcoding is an operation that generally uses a large amount of computational resources, a server that needs to provide a service to a plurality of clients in real time may perform transcoding in advance and may store a result file in advance and then may provide the service to meet a corresponding request.

However, in recent times, with the spread of technology such as cloud, a streaming service request for multimedia files uploaded by users are on the increase and user terminals are also diversified into a tablet personal computer (PC), a smartphone, a smart television (TV), and the like. Accordingly, real-time transcoding of performing transcoding simultaneously with execution of streaming in response to a user request may be performed. Real-time transcoding is enabled through development in the computing performance of the server.

In the related art, settings for transcoding are configured prior to starting the transcoding and used until the transcoding is terminated. Accordingly, another image may not be added during a transcoding process. In addition, once an image is added, the added image may not be easily removed. Also, since the existing transcoding generally configures an operation of switching an input image based on a compressed bitstream, precise switching is impossible.

### SUMMARY OF THE INVENTION

One or more example embodiments provide a transcoder design that may mix or switch an input image during a real-time transcoding process.

One or more example embodiments also provide a transcoder design that may perform continuous transcoding using limited resources by adding an image or by removing the added image.

One or more example embodiments also provide a transcoder design that may perform precise switching control on an input image based on a frame unit and may achieve a mixing or transition effect between images.

According to an aspect of at least one example embodiment, there is provided a real-time transcoding method performed by a server configured as a computer. The server includes a transcoder including a decoder, a mixer, and an encoder, and the real-time transcoding method includes performing real-time transcoding of a main image using the transcoder; adding a sub image or removing the added sub image at a front end of the mixer of the transcoder; and mixing or replacing the sub image using the mixer of the transcoder during real-time transcoding of the main image.

The mixing or the replacing of the sub image may include queuing the main image during a desired period of time using a buffer included at a front end of the decoder to mix or replace the sub image.

The transcoder may be configured to provide a packet queue for delaying the main image at a front end of the decoder to mix or replace the sub image.

The mixing or the replacing of the sub image may include combining the main image and the sub image into a single image using the mixer of the transcoder.

The mixing or the replacing of the sub image may include performing a real-time input replacement function by connecting the sub image or by releasing the connection of the sub image using the mixer of the transcoder during real-time transcoding of the main image.

The real-time transcoding method may further include receiving an absolute timestamp value from a remote controller or a server configured to provide the sub image. The mixing or the replacing of the sub image may include mixing or replacing the sub image through time synchronization based on the absolute timestamp value.

The sub image may be preloaded prior to being processed at the mixer of the transcoder to minimize an output delay of the sub image.

The mixing or the replacing of the sub image may include performing time synchronization on video data and audio data by sharing a processing time between a video mixer and an audio mixer of the transcoder with respect to the main image and the sub image.

The performing of the time synchronization may include setting a greater value between a current video processing time and a current audio processing time as a start time for playing a corresponding image in response to an image being connected.

The performing of the time synchronization may include releasing a connection of a corresponding image in response to the image being terminated and processing of a video and an audio being completed.

The mixing or the replacing of the sub image may include adjusting a reference time for replacing the sub image based on a greater value between a video play time and an audio play time.

The mixing or the replacing of the sub image may include inserting mute data into a section corresponding to a time difference between the audio play time and the play video time in response to the audio play time being less than the video play time; and repeating a specific frame in a section corresponding to a time difference between the video play time and the audio play time in response to the video play time being less than the audio play time.

According to an aspect of at least one example embodiment, there is provided a real-time transcoding system of a server configured as a computer, the real-time transcoding system including, as a transcoder for real-time transcoding, a decoder configured to decode a main image and a sub image; a mixer configured to mix the decoded main image and sub image into a single image; and an encoder configured to encode the mixed image. The mixer is configured to mix or replace the sub image during real-time transcoding of the main image by adding the sub image or removing the added sub image at a front end of the mixer.

According to some example embodiments, it is possible to provide a transcoder technique capable of mixing or switching an input image during a real-time transcoding process.

Also, according to some example embodiments, it is possible to provide a transcoder technique capable of performing continuous transcoding using limited resources by adding an image or by removing the added image.

Also, according to some example embodiments, it is possible to perform precise switching control based on a frame unit by performing a real-time transcoding operation based on a decoded frame instead of using a compressed bitstream, and to achieve a mixing or transition effect between images. Accordingly, there is no need to limit a format of a container or a codec.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 is a diagram illustrating an example of a network environment according to one embodiment;

FIG. 2 is a block diagram illustrating an example of a configuration of an electronic device and a server according to one embodiment;

FIG. 3 is a block diagram illustrating an example of components includable in a real-time transcoding system according to one embodiment;

FIG. 4 is a block diagram illustrating an example of an operation of a source that is an input configuration of a real-time transcoding system according to one embodiment;

FIG. 5 is a block diagram illustrating an example of an operation of a writer that is an output configuration of a real-time transcoding system according to one embodiment;

FIGS. 6 and 7 are block diagrams illustrating examples of an operation of a transform that is an image edition configuration of a real-time transcoding system according to one embodiment;

FIG. 8 illustrates an example of describing an output traffic aspect based on precoding of a transform that is an image edition configuration according to one embodiment;

FIG. 9 is a diagram illustrating an example of a time synchronization of a transform that is an image edition configuration according to one embodiment;

FIG. 10 illustrates an example of describing an image connection process of a transform that is an image edition configuration according to one embodiment; and

FIGS. 11, 12 and 13 are diagrams illustrating examples of an image replacement process of a transform that is an image edition configuration according to additional embodiments.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION OF THE INVENTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording media, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different from that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

The example embodiments relate to a real-time transcoding technique, and more particularly, to a method that may mix or switch an input image during a real-time transcoding process.

The example embodiments disclosed herein may embody a transcoder design for real-time image composition and may achieve many advantages, such as efficiency, reasonableness, compatibility, cost reduction, and the like.

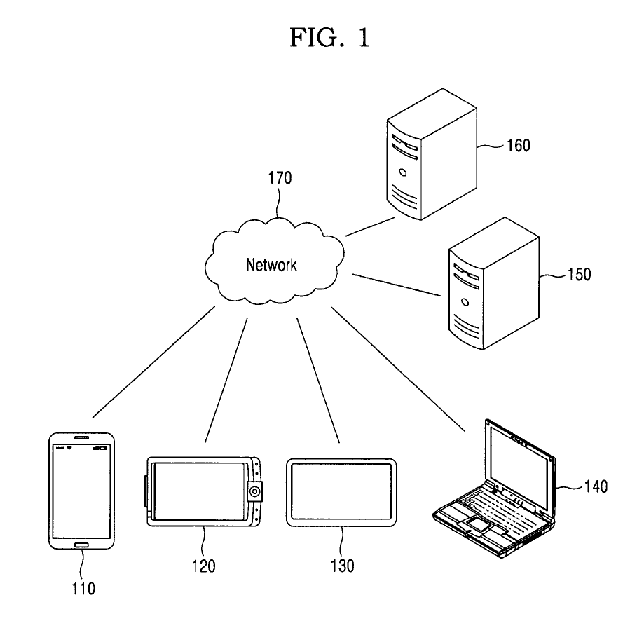

FIG. 1 is a diagram illustrating an example of a network environment according to at least one example embodiment. Referring to FIG. 1, the network environment includes a plurality of electronic devices 110, 120, 130, 140, a plurality of servers 150, 160, and a network 170. FIG. 1 is provided as an example only and thus, a number of electronic devices and/or a number of servers are not limited thereto.

Each of the plurality of electronic devices 110, 120, 130, 140 may be a fixed terminal or a mobile terminal configured as a computer device. For example, the plurality of electronic devices 110, 120, 130, 140 may be a smartphone, a mobile phone, a navigation device, a computer, a laptop computer, a digital broadcasting terminal, a personal digital assistant (PDA), a portable multimedia player (PMP), a tablet personal computer (PC), and the like. For example, the electronic device 110 may communicate with other electronic devices 120, 130, 140, and/or the servers 150, 160 over the network 170 in a wired communication manner or in a wireless communication manner.

The communication scheme is not particularly limited and may include a communication method that uses a near field communication between devices as well as a communication method using a communication network, for example, a mobile communication network, the wired Internet, the wireless Internet, a broadcasting network, a satellite network, etc., which may be included in the network 170. For example, the network 170 may include at least one of network topologies that include, for example, a personal area network (PAN), a local area network (LAN), a campus area network (CAN), a metropolitan area network (MAN), a wide area network (WAN), a broadband network (BBN), the Internet, and the like. Also, the network 170 may include at least one of network topologies that include a bus network, a star network, a ring network, a mesh network, a star-bus network, a tree or hierarchical network, and the like. However, these are only examples and the example embodiments are not limited thereto.

Each of the servers 150, 160 may be configured as a computer apparatus or a plurality of computer apparatuses that provides instructions, codes, files, contents, services, and the like through communication with the plurality of electronic devices 110, 120, 130, 140 over the network 170.

For example, the server 160 may provide a file for installing an application to the electronic device 110 connected through the network 170. In this case, the electronic device 110 may install the application using the file provided from the server 160. Also, the server 160 may access the server 150 under control of at least one program, for example, browser or the installed application, or an operating system (OS) included in the electronic device 110, and may use a service or content provided from the server 150. For example, when the electronic device 110 transmits a service request message to the server 150 through the network 170 under control of the application, the server 150 may transmit a code corresponding to the service request message to the electronic device 110 and the electronic device 110 may provide content to a user by configuring and displaying a screen according to the code under control of the application.

According to the example embodiments, the server 150 may serve as a streaming server for real-time transcoding as a platform that provides a multimedia streaming service. Here, the server 150 may perform a real-time transcoding operation based on a decoded frame and may include a transcoder design that may mix or switch an input image during a real-time transcoding process.

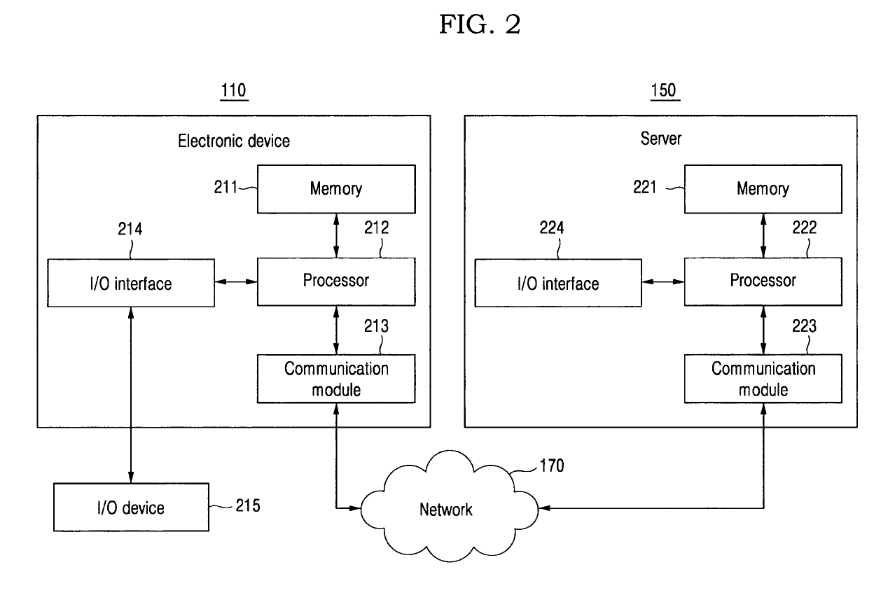

FIG. 2 is a block diagram illustrating an example of a configuration of an electronic device and a server according to one embodiment. FIG. 2 illustrates a configuration of the electronic device 110 as an example for a single electronic device and illustrates a configuration of the server 150 as an example for a single server. The same or similar components may be applicable to other electronic devices 120, 130, 140, or the server 160, and also to still other electronic devices or still other servers.

Referring to FIG. 2, the electronic device 110 includes a memory 211, a processor 212, a communication module 213, and an input/output (I/O) interface 214, and the server 150 includes a memory 221, a processor 222, a communication module 223, and an I/O interface 224. The memory 211, 221 may include a permanent mass storage device, such as random access memory (RAM), read only memory (ROM), a disk drive, a solid state drive, a flash memory, etc., as a non-transitory computer-readable storage medium. Also, an OS or at least one program code, for example, a code for an exclusive application or a browser installed and executed on the electronic device 110, etc., may be stored in the memory 211, 221. Such software components may be loaded from another non-transitory computer-readable storage medium separate from the memory 211, 221 using a drive mechanism. The other non-transitory computer-readable storage medium may include, for example, a floppy drive, a disk, a tape, a DVD/CD-ROM drive, a memory card, etc. According to other example embodiments, software components may be loaded to the memory 211, 221 through the communication module 213, 223, instead of, or in addition to, the non-transitory computer-readable storage medium. For example, at least one program may be loaded to the memory 211, 221 based on, for example, an application installed by files provided over the network 170 from developers or a file distribution system, for example, the server 160, which provides an installation file of the application.

The processor 212, 222 may be configured to process computer-readable instructions, for example, the aforementioned at least one program code, of a computer program by performing basic arithmetic operations, logic operations, and I/O operations. The computer-readable instructions may be provided from the memory 211, 221 and/or the communication module 213, 223 to the processor 212, 222. For example, the processor 212, 222 may be configured to execute received instructions in response to the program code stored in the storage device, such as the memory 211, 222.

The communication module 213, 223 may provide a function for communication between the electronic device 110 and the server 150 over the network 170, and may provide a function for communication between the electronic device 110 and/or the server 150 and another electronic device, for example, the electronic device 120 or another server, for example, the server 160. For example, the processor 212 of the electronic device 110 may transfer a request created based on a program code stored in the storage device such as the memory 211, to the server 150 over the network 170 under control of the communication module 213. Inversely, a control signal, an instruction, content, a file, etc., provided under control of the processor 222 of the server 150 may be received at the electronic device 110 through the communication module 213 of the electronic device 110 by going through the communication module 223 and the network 170. For example, a control signal, an instruction, content, a file, etc., of the server 150 received through the communication module 213 may be transferred to the processor 212 or the memory 211, and content, a file, etc., may be stored in a storage medium further includable in the electronic device 110.

The I/O interface 214 may be a device used for interface with an I/O device 215. For example, an input device may include a keyboard, a mouse, a microphone, a camera, etc., and an output device may include a device, such as a display for displaying a communication session of the application. As another example, the I/O interface 214 may be a device for interface with an apparatus in which an input function and an output function are integrated into a single function, such as a touch screen. In detail, when processing instructions of the computer program loaded to the memory 211, the processor 212 of the electronic device 110 may display a service screen configured using data provided from the server 150 or the electronic device 120, or may display content on a display through the I/O interface 214.

According to other example embodiments, the electronic device 110 and the server 150 may include a greater or lesser number of components than a number of components shown in FIG. 2. For example, the electronic device 110 may include at least a portion of the I/O device 215, or may further include other components, for example, a transceiver, a global positioning system (GPS) module, a camera, a variety of sensors, a database, and the like. In detail, if the electronic device 110 is a smartphone, the electronic device 110 may be configured to further include a variety of components, for example, an accelerometer sensor, a gyro sensor, a camera, various physical buttons, a button using a touch panel, an I/O port, a vibrator for vibration, etc., which are generally included in the smartphone.

Hereinafter, example embodiments of a transcoder design and a real-time transcoding method for real-time image composition will be described.

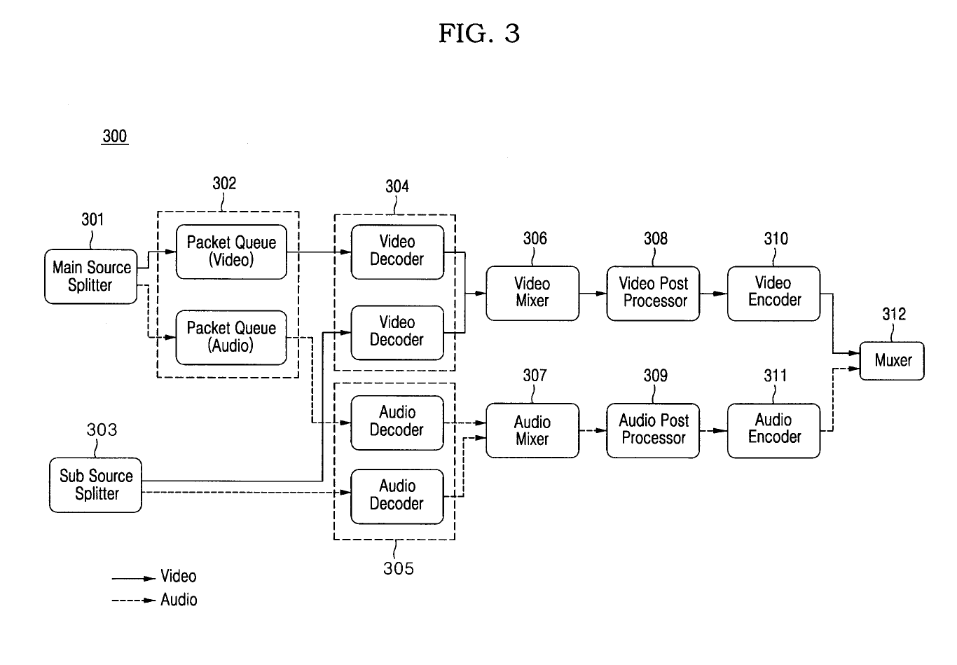

FIG. 3 is a block diagram illustrating an example of components includable in a real-time transcoding system according to one embodiment. FIG. 3 illustrates an entire configuration of a real-time transcoding system 300. Components of the real-time transcoding system 300 may be included in the processor 222 of the server 150 that serves as the streaming server described above with respect to FIGS. 1 and 2. The processor 222 and the components of the processor 222 may control the server 150 to perform a real-time transcoding method that is described below. Here, the processor 222 and the components of the processor 222 may be configured to execute instructions according to a code of at least one program and a code of an OS included in the memory 221. Also, the components of the processor 222 may be representations of different functions performed by the processor 222 in response to a control instruction provided from at least one program or the OS.

Referring to FIG. 3, the real-time transcoding system 300 includes a main source splitter 301, a buffer 302, for example, a packet queue, a sub source splitter 303, a video decoder 304, an audio decoder 305, a video mixer 306, an audio mixer 307, a video post processor 308, an audio post processor 309, a video encoder 310, an audio encoder 311, and a multiplexer (muxer) 312.

The real-time transcoding system 300 configured as above provides a transcoder design for compositing an additional image with a live image that is to be provided in real time. In particular, in the case of editing an image in real time, the real-time transcoding system 300 may process a sub image that is dynamically added or removed at a front end of the video mixer 306 or the audio mixer 307 using the video mixer 306 or the audio mixer 307, and may mix or switch an input image using the video mixer 306 or the audio mixer 307 based on a frame that is decoded through the video decoder 304 or the audio decoder 305.

The real-time transcoding system 300 may generally include an input configuration (source) from a source end including the main source splitter 301 and the buffer 302, for example, the packet queue, to the video decoder 304 and the audio decoder 305, an image edition configuration (transform) including the video mixer 306, the audio mixer 307, the video post processor 308, and the audio post processor 309, and an output configuration (writer) including the video encoder 310, the audio encoder 311, and the multiplexer 312.

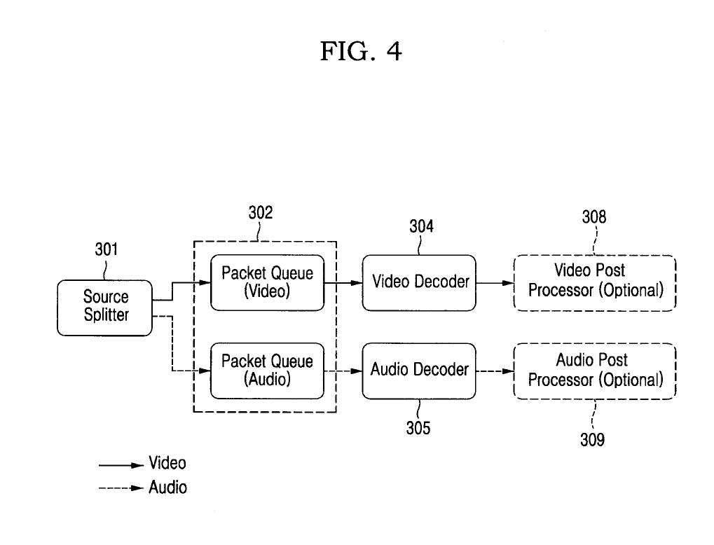

An operation of the input configuration (source) will be described. Referring to FIG. 4, a main image may be separated into video data and audio data through the main source splitter 301, and each of a packet of the video data and a packet of the audio data may be queued through the buffer 302 during a desired period of time. Here, the buffer 302 may serve to artificially delay a main image that is a live image during a desired period of time in order to add another image or remove the added image during a real-time transcoding process. In particular, the buffer 302 provides a packet queue for remote control associated with an image composition and may perform a delay function by stacking an input bitstream for the remote control in an internal queue. The live image may go through the packet queue of the buffer 302 before passing through the video mixer 306 and the audio mixer 307 of the image edition configuration (transform). Accordingly, the function of adding the other image or removing the added image during the process of transcoding the live image may be performed.

An input bitstream may be separated into video data and audio data at the input configuration (source) and thereby be present as compressed packets. A compressed video bitstream and audio bitstream may be buffered through the buffer 302 during a desired period of time and then be transferred to the video decoder 304 and the audio decoder 305, respectively. The real-time transcoding system 300 may perform live input time synchronization at the input configuration (source). For example, the real-time transcoding system 300 may receive an absolute timestamp value that is transferred from a remote controller or the server 150 providing a sub image, for example, an advertisement and the like. The absolute timestamp value may be used through the main source splitter 301 or the sub source splitter 303. The main source splitter 301 or the sub source splitter 303 may perform time synchronization with the server 150 or the remote controller based on the absolute timestamp value. That is, the absolute timestamp value commonly recognizable at the main source splitter 301 and the sub source splitter 303 may be acquired from the server 150 or the remote controller. An instruction for real-time image composition may be transmitted and received between the main source splitter 301 and the sub source splitter 303 based on the absolute timestamp value. The input configuration (source) may be combined with the packet queue of the buffer 302. Accurate and precise image switching may be performed by applying a switching instruction of the server 150 or the remote controller to the input configuration (source) before the live image passes through the video mixer 306 and the audio mixer 307.

The input configuration (source) of FIG. 4 is used to describe a bitstream corresponding to the live image. Referring to FIG. 3, a sub image connected to a sub-source may be separated into a video bitstream and an audio bitstream through the sub source splitter 303 due to delay of the live image. The video bitstream and the audio bitstream may be transferred to the video decoder 304 and the audio decoder 305.

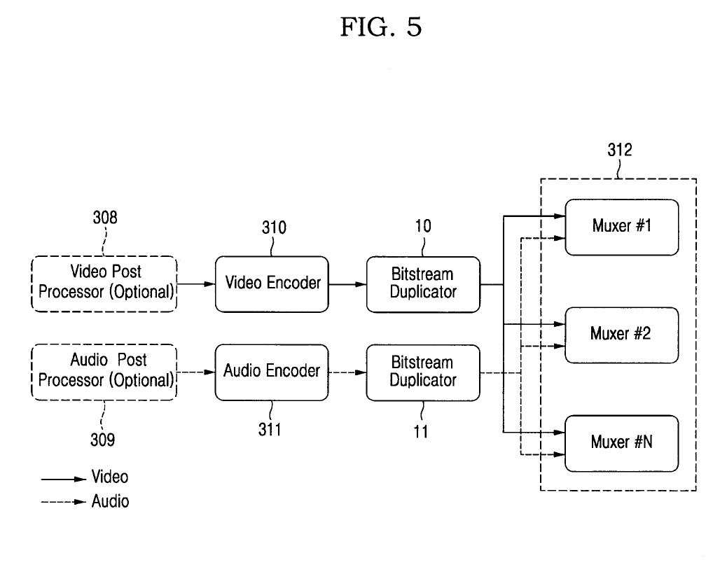

The output configuration (writer) is a configuration of generating an input bitstream as a result in a desired format. Referring to FIG. 5, for example, a plurality of results may be generated by duplicating a video bitstream and an audio bitstream encoded through the video encoder 310 and the audio encoder 311 using bitstream duplicators 10 and 11, respectively. That is, the output configuration (writer) may generate a plurality of output files using an encoded single bitstream, and may, for example, simultaneously perform network live streaming and MP4 file storage. As another example, a multi-output structure of generating a plurality of encoding results using a single input may be applicable using a scheme of duplicating a decoded video frame and a decoded audio frame. For example, HD image encoding and SD image encoding may be simultaneously performed. A video frame and an audio frame may be duplicated and transferred to an HD encoder and an SD encoder.

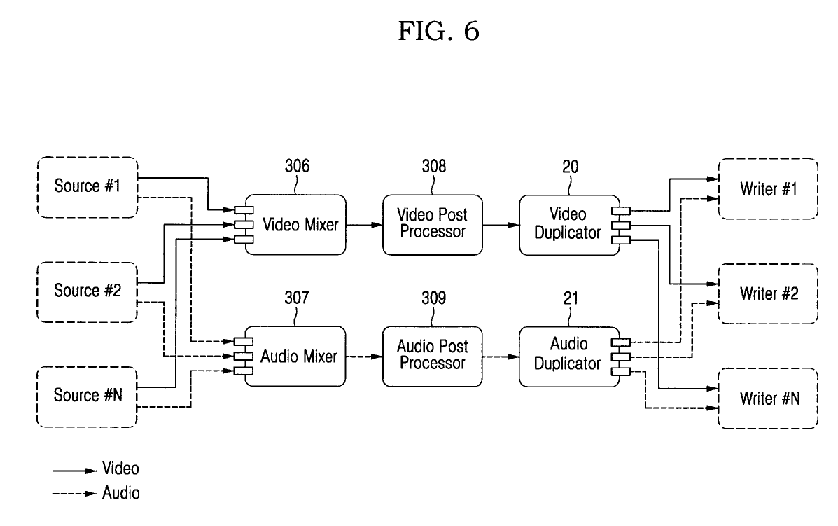

The image edition configuration (transform) may serve to mix a plurality of input images or switch between the input images. Referring to FIG. 6, a plurality of videos and audios that are decoded at two or more input configurations (source #1, source #2, . . . , source #N) may sequentially pass through the video mixer 306 and the audio mixer 307, the video post processor 308 and the audio post processor 309, and a video duplicator 20 and an audio duplicator 21, and then be transferred to one or more output configurations (writer #1, writer #2, . . . , writer #N). Here, the image edition configuration (transform) may combine the plurality of input images input through the input configurations (source #1, source #2, . . . , source #N) into a single input image and transfer the combined input image to the output configurations (writer #1, writer #2, . . . , writer #N). The image edition configuration (transform) may perform a real-time input replacement (switching) function by additionally connecting an image or removing the added image during a transcoding operation.

According to example embodiments, it is possible to perform an accurate and precise switching control based on a frame unit by performing a switching operation at the image edition configuration (transform) based on a frame decoded through the input configuration (source), instead of performing the switching operation based on a compressed bitstream within the input configuration (source).

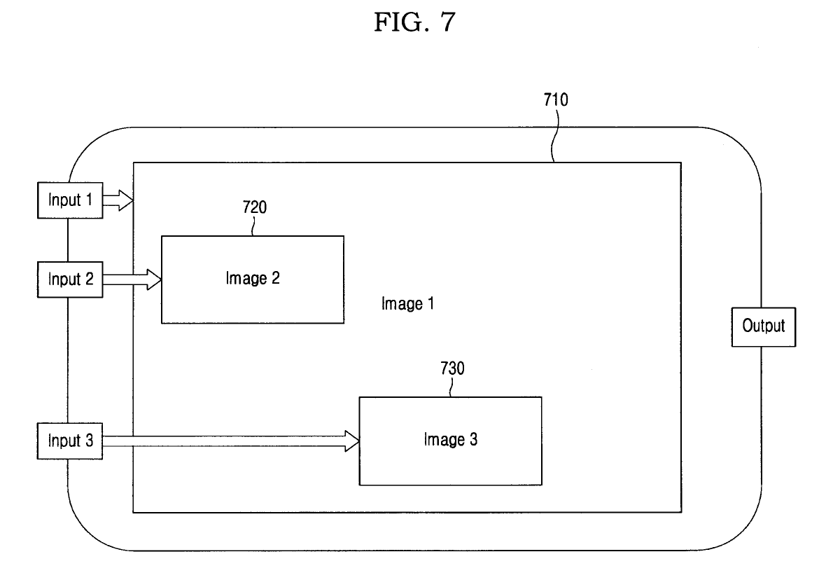

FIG. 7 illustrates an example of a basic operation of an image edition configuration (transform). Hereinafter, although a description is made based on an operation of a video mixer, the description may be applicable to an operation of an audio mixer. Thus, a further description is omitted.

The image edition configuration (transform) may acquire available image data from each of input 1, input 2, and input 3 of the input configuration (source). Here, whether the image data is available may be determined based on an absolute timestamp value transferred from the server 150 or the remote controller.

The image edition configuration (transform) may sequentially draw each piece of image data acquired from the input configuration (source) based on a screen combination setting. Here, it is possible to achieve a screen switching effect by slightly changing the screen combination setting, for example, the location, transparency, etc., per each frame.

Once each piece of image data is drawn based on the screen combination setting, the image edition configuration (transform) may output a completed frame to the output configuration (writer). For example, referring to FIG. 7, when it is assumed that input 1, input 2, and input 3 are connected to the video mixer 306 and the audio mixer 307 of the image edition configuration (transform), the image edition configuration (transform) may acquire decoded images 710, 720, and 730 from the respective inputs sequentially, for example, in order of input 1→input 2→input 3, may draw the acquired images 710, 720, and 730 on a common page based on a set combination, and may output a completed frame in which all of the images 710, 720, and 730 acquired from input 1, input 2, and input 3 are drawn.

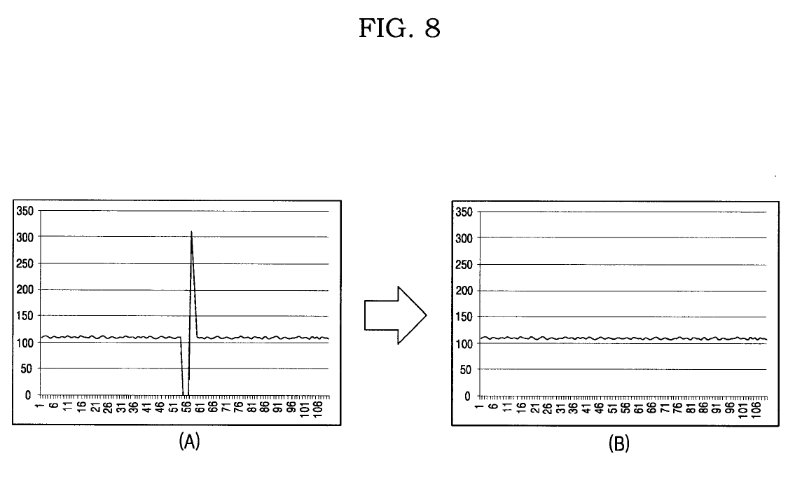

A preloading scheme may be applied to the image edition configuration (transform). In general, a desired data processing time is required to read an image file and to play the read image file. An output delay may be minimized by connecting an input image in advance before image data is processed, for example, drawn at the video mixer 306 and the audio mixer 307 of the image edition configuration (transform). That is, the real-time transcoding system 300 connects the input image and preloads data until the connected input image is operated. In the case of applying a real-time loading scheme, as shown in a graph (A) of FIG. 8, output traffic according to loading temporarily drops. On the other hand, in the case of applying a preloading scheme, as shown in a graph (B) of FIG. 8, output traffic is maintained at a constant level.

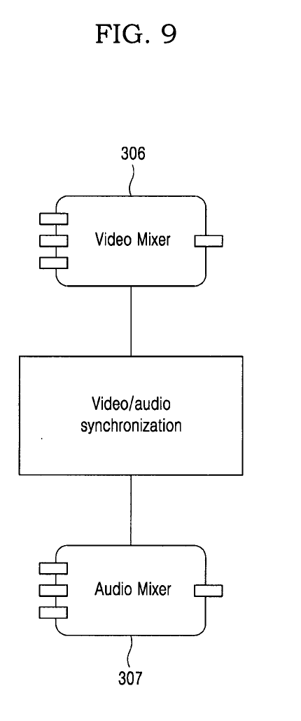

Video data and audio data may need to be synchronized at all times for real-time input switching at the image edition configuration (transform). A video play time and an audio play time of the input image may differ from each other. Also, when processing video data and audio data, the complexities associated with these processes may differ from each other. Accordingly, unless synchronization is performed, a difference in a processing rate between the video data and the audio data may increase. Since all of the video time and the audio time currently being processed need to be considered for image switching, it may be difficult to immediately switch an image. To address the above issue, the image edition configuration (transform) may synchronize a time between video data and audio data currently being processed. Referring to FIG. 9, the image edition configuration (transform) may perform time synchronization between the video data and the audio data by allowing a processing time to be shared between the video mixer 306 and the audio mixer 307. To this end, if a difference in a processing rate between video data and audio data exceeds a threshold value, for example, 1 second, the image edition configuration (transform) makes data corresponding to a relatively fast processing rate wait and waits for data being delayed. Further, if an input image is connected in real time, the image edition configuration (transform) may set a greater value between a current video processing time and a current audio processing time as a start time of the input image. The image edition configuration (transform) may determine whether to terminate the input image and a point in time at which the input image is to be terminated by allowing a processing time to be shared between a video processor and an audio processor. Once the input image is terminated, the image edition configuration (transform) may verify that processing of the video and the audio is all completed and then may release the connection of the corresponding image.

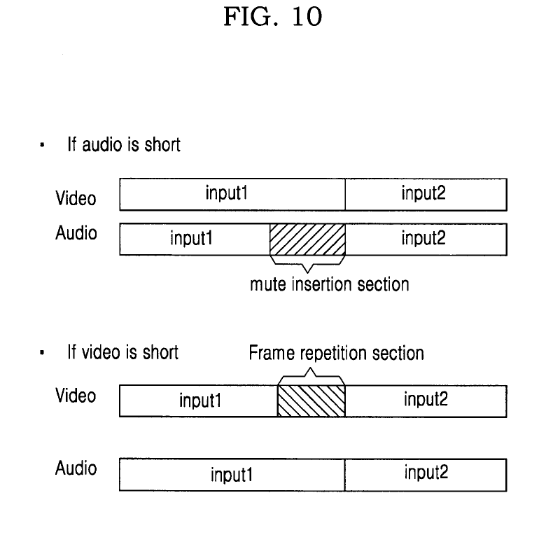

A difference may occur between a video play time and an audio play time in a media stream of the same file. In the case of performing processing based on a play time of a specific frame, last few frames may be missed. For example, since an advertising image generally includes important information, such as a logo, in a last frame, missing of the last frame may become a serious issue. To address the issue, the image edition configuration (transform) may adjust a reference time of an image connection based on a greater value between the video play time and the audio play time when performing image switching in real time. For example, referring to FIG. 10, in the case of connecting an input image of input 2 to an input image of input 1, the audio play time may be less than the video play time. In this case, the image edition configuration (transform) may adjust the video play time and the audio play time to match by inserting mute data into a section by a corresponding time difference. Meanwhile, if the audio play time is less than the video play time, the image edition configuration (transform) may adjust a difference between the video play time and the audio play time by repeatedly drawing a specific frame, for example, a last frame, during a section by a corresponding time difference.

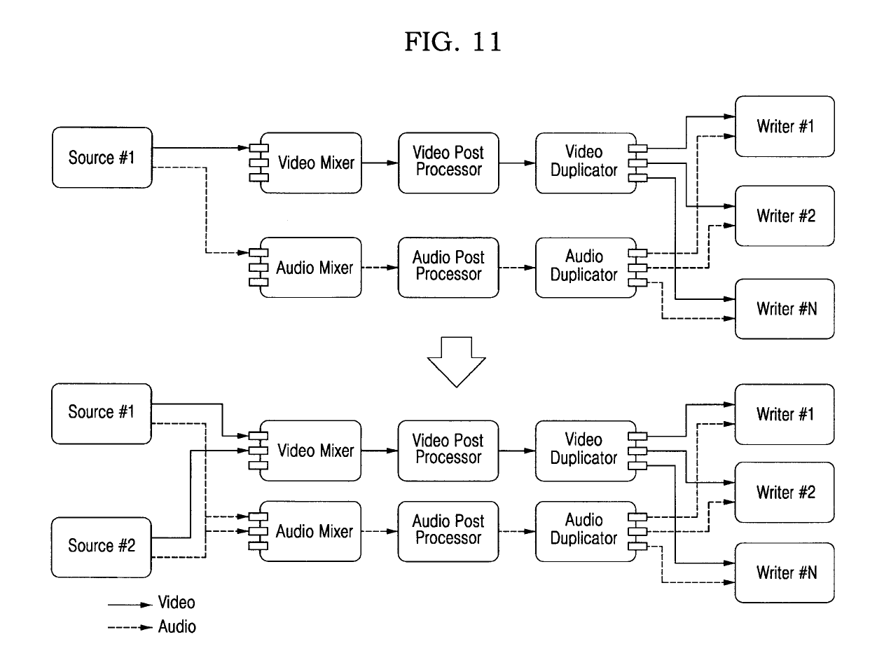

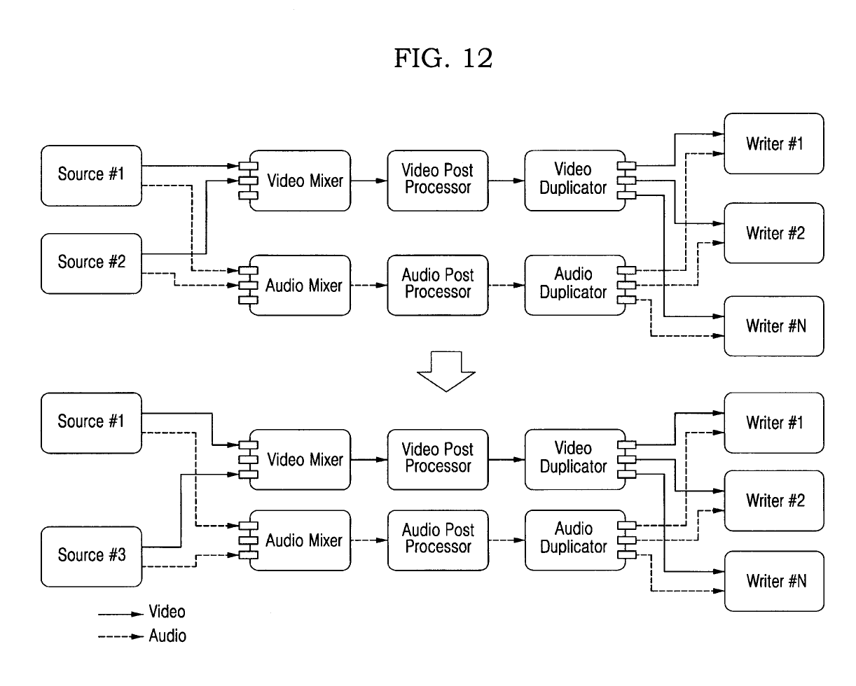

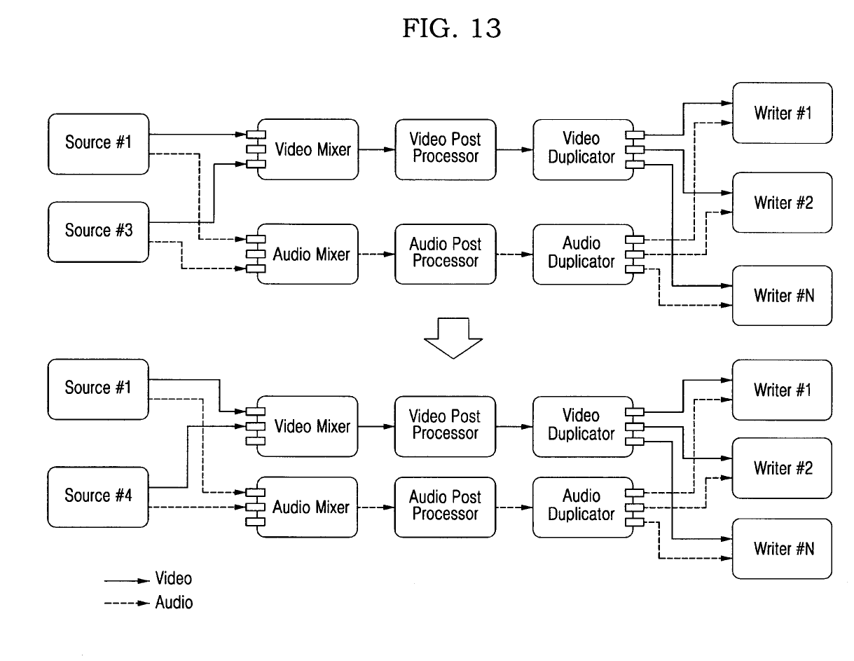

FIGS. 11 through 13 are diagrams illustrating examples of an image connection process based on real-time image switching according to further embodiments. Here, it is assumed that three sub images are consecutively added during transcoding of a live image. When the three sub images are connected in advance, the real-time transcoding system 300 delays an output of a first image (live image) if an addition point in time of a second image that is a sub image arrives in a state in which the first image connected to a source #1 is being processed at an image edition configuration (transform), and transfers the second image connected to a source #2 to the image edition configuration (transform) as shown in FIG. 11. Referring to FIG. 12, once a play time of the second image is terminated, the real-time transcoding system 300 releases the connection of the second image from the image edition configuration (transform) and replaces the second image with a third image that is a subsequent sub image and connected to a source #3. Referring to FIG. 13, once a play time of the third is image is terminated, the real-time transcoding system 300 releases the connection of the third image from the image edition configuration (transform) and replaces the third image with a fourth image that is a subsequent sub image and connected to a source #4.

Accordingly, to edit an image in real time, the real-time transcoding system 300 may dynamically add or remove an input image at a front end of a mixer of a transcoder, and may mix or switch the input image based on a decoded frame during real-time transcoding.

The real-time transcoding method according to example embodiments may include two or more operations based on the detailed description made above with reference to FIGS. 1 through 13.

As described above, according to some example embodiments, it is possible to provide a transcoder technique capable of mixing or switching an input image during a real-time transcoding process. Also, according to some example embodiments, it is possible to provide a transcoder technique capable of performing continuous transcoding using limited resources by adding an image or by removing the added image. Also, according to some example embodiments, it is possible to perform precise switching control based on a frame unit by performing a real-time transcoding operation based on a decoded frame instead of using a compressed bitstream, and to achieve a mixing or transition effect between images. Accordingly, there is no need to limit a format of a container or a codec.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A real-time transcoding method performed by a server configured as a computer, wherein the server has a transcoder including a decoder, a mixer, and an encoder, the method comprising:
performing real-time transcoding of a main image using the transcoder;
adding a sub image or removing the added sub image at a front end of the mixer of the transcoder; and
mixing or replacing the sub image using the mixer of the transcoder during real-time transcoding of the main image.

2. The method of claim 1, wherein the mixing or the replacing of the sub image comprises queuing the main image during a desired period of time using a buffer included at a front end of the decoder.

3. The method of claim 1, wherein the transcoder is configured to provide a packet queue for delaying the main image at a front end of the decoder to mix or replace the sub image.

4. The method of claim 1, wherein the mixing or the replacing of the sub image comprises combining the main image and the sub image into a single image using the mixer of the transcoder.

5. The method of claim 1, wherein the mixing or the replacing of the sub image comprises performing a real-time input replacement function by connecting the sub image or by releasing the connection of the sub image using the mixer of the transcoder during real-time transcoding of the main image.

6. The method of claim 1, further comprising:
receiving an absolute timestamp value from a remote controller or a server configured to provide the sub image,
wherein the sub image is mixed or replaced through time synchronization based on the absolute timestamp value.

7. The method of claim 1, wherein the sub image is preloaded prior to being processed at the mixer of the transcoder to minimize an output delay of the sub image.

8. The method of claim 1, wherein the mixing or the replacing of the sub image comprises performing time synchronization on video data and audio data by sharing a processing time between a video mixer and an audio mixer of the transcoder with respect to the main image and the sub image.

9. The method of claim 8, wherein the performing of the time synchronization comprises setting a greater value between a current video processing time and a current audio processing time as a start time for playing a corresponding image in response to an image being connected.

10. The method of claim 8, wherein the performing of the time synchronization comprises releasing a connection of a corresponding image in response to the image being terminated and processing of a video and an audio being completed.

11. The method of claim 1, wherein the mixing or the replacing of the sub image comprises adjusting a reference time for replacing the sub image based on a greater value between a video play time and an audio play time.

12. The method of claim 11, wherein the mixing or the replacing of the sub image comprises:
inserting mute data into a section corresponding to a time difference between the audio play time and the play video time in response to the audio play time being less than the video play time; and
repeating a specific frame in a section corresponding to a time difference between the video play time and the audio play time in response to the video play time being less than the audio play time.

13. A real-time transcoding system of a server configured as a computer, comprising:
a transcoder including,
a decoder configured to decode a main image and a sub image;
a mixer configured to mix the decoded main image and sub image into a single image; and
an encoder configured to encode the mixed image,
wherein the mixer is configured to mix or replace the sub image during real-time transcoding of the main image by adding the sub image or removing the added sub image at a front end of the mixer.

14. The real-time transcoding system of claim 13, wherein the transcoder further comprises a buffer configured to provide a packet queue for delaying the main image at a front end of the decoder to mix or replace the sub image.

15. The real-time transcoding system of claim 13, wherein the transcoder is configured to receive an absolute timestamp value from a remote controller or a server configured to provide the sub image and to mix or replace the sub image through time synchronization based on the absolute timestamp value.

16. The real-time transcoding system of claim 13, wherein the transcoder is configured to preload the sub image prior to processing the sub image at the mixer to minimize an output delay of the sub image.

17. The real-time transcoding system of claim 13, wherein the transcoder is configured to perform time synchronization on video data and audio data by sharing a processing time between a video mixer and an audio mixer with respect to the main image and the sub image.

18. The real-time transcoding system of claim 17, wherein the transcoder is configured to set a greater value between a current video processing time and a current audio processing time as a start time for playing a corresponding image in response to an image being connected.

19. The real-time transcoding system of claim 13, wherein the transcoder is configured to adjust a reference time for replacing the sub image based on a greater value between a video play time and an audio play time.

20. The real-time transcoding system of claim 19, wherein the transcoder is configured to insert mute data into a section corresponding to a time difference between the audio play time and the play video time in response to the audio play time being less than the video play time, and to repeat a specific frame in a section corresponding to a time difference between the video play time and the audio play time in response to the video play time being less than the audio play time.
